(19) United States
(12) Patent Application Publication
(10) Pub. No.: US 2026/0176420 A1
(43) Pub. Date: Jun. 25, 2026

(54) BIO BASED POLYAMIDES AND CORRESPONDING POLYMER COMPOSITIONS

(71) Applicant: SYENSQO SPECIALTY POLYMERS USA, LLC, Alpharetta, GA (US)

(72) Inventors: Ryan Mondschein, Cumming, GA (US); Stéphane Jéol, Saint-Genis-Laval (FR); Peter Mushenheim, Atlanta, GA (US); Joel Flores, Anaheim, CA (US)

(73) Assignee: SYENSQO SPECIALTY POLYMERS USA, LLC, Alpharetta, GA (US)

(21) Appl. No.: 19/112,950

(22) PCT Filed: Sep. 19, 2023
(86) PCT No.: PCT/EP2023/075823

§ 371 Date: Mar. 18, 2025

Related U.S. Application Data
(60) Provisional application No. 63/407,853, filed on Sep. 19, 2022.

(30) Foreign Application Priority Data
Oct. 14, 2022 (EP) 22201546.3

(51) Int. Cl. C08G 69/26; C08K 7/02

(52) U.S. Cl. CPC C08G 69/265; C08K 7/02

(57) ABSTRACT

Described herein is a biobased semi-crystalline copolyamide having a combination of thermal properties and being suitable to prepare unfilled and fiber-reinforced thermoplastic compounds and composites prepared from first diamine (DA1) selected in the group consisting of 2,2,4-trimethyl-1,6-hexanediamine (2,2,4-TMD), 2,4,4-trimethyl-1,6-hexanediamine (2,4,4-TMD) and a mixture thereof and a second diamine (DA2) selected in the group consisting of 1,9-nonanediamine (C9), 1,10-decanediamine (C10) and a mixture thereof.

This is a national stage entry of PCT/EP2023/075823, filed on 19 Sep. 2023, which PCT application which claims priority of U.S. patent application No. 63/407,853 filed on 19 Sep. 2022 and European patent application No. 22201546.3 filed on 14 Oct. 2022, the content of which being entirely incorporated herein by reference for all purposes. In case of any incoherency between the PCT application and the two applications that would affect the clarity of a term or expression, it should be made reference to the PCT application only.

### FIELD OF THE INVENTION

The invention relates to a biobased semi-crystalline copolyamide having a combination of thermal properties and being suitable to prepare unfilled and fiber-reinforced thermoplastic compounds and composites.

### BACKGROUND OF THE INVENTION

Aliphatic polyamides such as the very well-known PA6 and PA66 are a class of thermoplastic resins much appreciated as they are easy to process and generally have high melting points. They also exhibit high heat resistance values, in particular when reinforced with fibers or fillers. However, they typically have high water absorption values of up to 9% when stored in water.

The aliphatic polyamides cannot be used for many applications that require stringent requirements placed on dimensional stability which also apply to wet or moist conditions. Not only are the dimensions altered by water absorption but also the mechanical properties. Water absorption reduces stiffness and strength to a fraction of their original values. There are however many applications involving mechanical load in contact with water or ambient moisture that require dimensional stability and maintenance of the mechanical properties.

Semi-aromatic polyamides have been developed to address these problems. Trogamid T5000 is a commercial amorphous polyamide composed of terephthalic acid and of a mixture of 2,2,4-trimethyl-1,6-hexanediamine (2,2,4-TMD) and 2,4,4-trimethyl-1,6-hexanediamine (2,4,4-TMD). This amorphous polyamide exhibits a high mechanical strength and a high toughness. However, it loses all of its mechanical integrity when exposed to temperatures higher than its Tg=150° C. (dry state) and in presence of water due to a high moisture absorption around 7.5 wt. %.

U.S. Pat. No. 8,871,862 discloses a copolyamide comprising, in reacted form a) 50 to 95 mol % of a first mixture consisting of terephthalic acid and one diamine selected from the group consisting of 1,9-nonanediamine, 1,10-decanediamine, 1,11-undecanediamine and 1,12-dodecanediamine, and b) 5 to 50 mol % of a second mixture consisting of terephthalic acid and at least one diamine selected from the group consisting of 2,2,4-trimethylhexamethylenediamine and 2,4,4-trimethylhexamethylenediamine, where the mol % values are based on the entirety of components a) and b), and at most 5 mol % of units which derive from one or more other monomers selected from the group consisting of an acid other than terephthalic acid, a lactam and an aminocarboxylic acid. U.S. Pat. No. 8,871,862 does not disclose the polyamide of the invention.

U.S. Pat. No. 4,495,328 describes semi-crystalline polyamides made of terephthalic acid and mixtures of hexamethylenediamine and TMD. That document gives PA6T/TMDT (60/40 in mol %) as an example, with a melting point of 310° C. This polyamide has a high melting point, which limits its processing window especially for extrusion where the polyamide needs to stay in the molten phase for an extended period of time.

U.S. Pat. No. 4,476,280 describes copolyamides made of terephthalic acid, isophthalic acid, and adipic acid, in combination with fossil based hexamethylenediamine and TMD. These copolyamides exhibit a high moisture absorption.

US 2012/095161 (D1) discloses a copolyamide comprising, in reacted form: a) 50 to 95 mol % of a first mixture comprising terephthalic acid and one diamine selected from the group consisting of 1,9-nonanediamine, 1,10-decanediamine, 1,11-undecanediamine and 1,12-dodecanediamine, and b) 5 to 50 mol % of a second mixture comprising terephthalic acid and at least one diamine selected from the group consisting of 2,2,4-trimethylhexamethylenediamine and 2,4,4-trimethylhexamethylenediamine. D1 discloses only the use of terephthalic acid in the inventive examples. According to an embodiment, the copolyamide may comprise at most 30 mol %, at most 25 mol %, at most 20 mol %, at most 15 mol %, at most 10 mol %, or at most 5 mol %, of units which derive from other monomers. D1 more particularly discloses the following examples:

TABLE I

| copolyamide 10.T/ | Tm | Tg | |
|---|---|---|---|
| TMD.T (in mol %) | (° C.) | (° C.) | Tm/Tg |
| 94/6 | 297 | 122 | 2.43 |
| 85/15 | 282 | 123 | 2.29 |
| 80/20 | 274 | 125 | 2.19 |
| 70/30 | 270 | 128 | 2.11 |
| 60/40 | 263 | 133 | 1.98 |
| 52/48 | 251 | 134 | 1.87 |

For a given Tg, they exhibit a high Tm.

EP 1795632 (D2) discloses a semi-aromatic copolyamide comprising a dicarboxylic acid unit (1) containing at least one first dicarboxylic acid unit selected from the group consisting of a terephthalic acid unit and an isophthalic acid unit, wherein the proportion of the first dicarboxylic acid unit is not less than 60% by mole relative to the total dicarboxylic acid unit, and (2) a diamine unit containing at least one first diamine unit selected from the group consisting of a 2,2,4-trimethylhexanediamine unit, a 2,4,4-trimethylhexanediamine unit, a 1,6-hexanediamine unit and at least one second diamine unit selected from the group consisting of a 1,9-nonanediamine unit and a 2-methyl-1,8-octanediamine unit, wherein the total proportion of the first diamine unit and the second diamine unit is not less than 60% by mole relative to the total diamine unit. Copolyamides B9 and B10 are based on the following components: diacid component: terephthalic acid (80 mol %)+isophthalic acid (20 mol %); diamine component: 2,2,4-trimethylhexanediamine (20 mol %)+1,9-nonanediamine (40 mol %)+2-methyl-1,8-octanediamine (40 mol %). D2 does not disclose a diamine component (A) as in the invention.

### Technical Problem

In the field of thermoplastic composites notably for automotive application, there is a growing need for polymer resins that exhibit a combination of wide processing window between the melting point (Tm) and the degradation point (Tdeg) of the resin, good crystallization speed and a high dimensional stability until at least 80° C. (under dry and humid conditions). Thus, the polymer resin needs to exhibit a high heat of fusion, a high glass temperature (Tg) and a melting point (Tm) which is high enough for thermal resistance but lower than 300° C. to still exhibit a good processability.

While it is beneficial to have a high Tg for thermal resistance and maintenance of the mechanical properties up to a high temperature, a resin having an easier processability is also sought after for the preparation of a thermoplastic composite. This explains that for a given Tg, the resin advantageously exhibits a limited Tm between 238° C. and 300° C., preferably between 238° C. and 290° C. (this value of 290° C. being excluded), and a Tm/Tg ratio which is limited so that, for a given Tg, the lower Tm in the above defined range, the better.

Moreover, the polymer resin needs to exhibit resistance to water, notably dimensional stability in the presence of moisture and resistance to hot water.

In addition, there is growing need to use polymer resins having a lower environmental footprint. Polymer resins exhibiting a high biobased content as determined according to ASTM D6866-22 are thus more and more sought after.

The polyamide of the invention aims at solving these technical problems.

### BRIEF DISCLOSURE OF THE INVENTION

The invention relates to a polyamide as disclosed in any one of claims 1-37. In particular, the invention relates to a polyamide as disclosed in embodiment (E*).

The invention also relates to the process of preparation of the polyamide of the invention as disclosed in claim 38.

The invention also relates to a thermoplastic composite as disclosed in any one of claims 39-40.

More precisions and details about these subject-matters are now provided below.

### GENERAL DEFINITIONS

These definitions apply to the present disclosure.

wt. % is a percentage by weight. Mol. % is a percentage by mole.

Unless otherwise stated, the proportions of recurring units in the polyamide are given in mol % and relative to the total proportion of recurring units in the polyamide.

When numerical ranges are indicated herein, the end-points of the ranges (even of open-ended ranges such as those comprising “at least” or “at most”) are included.

In the present application, unless otherwise indicated, any specific embodiment or technical feature relating to one of the subject-matters of the invention is applicable to and interchangeable with another embodiment or technical feature relating also to said subject matter and disclosed elsewhere in the application.

The proportions of diamines in the diamine component (A) are based on the total amount of diamines in the diamine component (A). The proportions of carboxylic diacids in the dicarboxylic acid component (B) are based on the total amount of dicarboxylic acids in the dicarboxylic acid component (B).

### DETAILED DESCRIPTION OF THE INVENTION

The invention relates to a semi-aromatic copolyamide (PA) comprising recurring units (R_{PA}) formed from the polycondensation of a diamine component (A) and a dicarboxylic acid component (B) wherein:
the diamine component (A) comprises, consists essentially of or consists of:
   a) a first diamine (DA1) selected in the group consisting of 2,2,4-trimethyl-1,6-hexanediamine (2,2,4-TMD), 2,4,4-trimethyl-1,6-hexanediamine (2,4,4-TMD) and a mixture thereof, and
   b) a second diamine (DA2) selected in the group consisting of 1,9-nonanediamine (C9), 1,10-decanediamine (C10) and a mixture thereof,
      wherein the molar ratio DA1/DA2 of the first diamine (DA1) over the second diamine (DA2) is between 5/95 and 47/53 and wherein the proportion of DA2 in the diamine component (A) is greater than or equal to 53.0 mol % (≥53.0 mol %), this proportion being based on the total amount of diamines in the diamine component (A);
the dicarboxylic acid component (B) comprises, consists essentially of or consists of:
   a) between 70.0 and 95.0 mol. % of terephthalic acid;
   b) between 5.0 (this value being excluded) and 30.0 mol. % of a diacid (DI) selected in the group consisting of isophthalic acid, adipic acid (AA), azelaic acid, sebacic acid, dodecanedioic acid, brassilic acid, 1,4-cyclohexanedicarboxylic acid (CHDA) and a mixture thereof;
   these proportions in mol % being based on the total amount of diacids in the dicarboxylic acid component (B).

The polyamide (PA) of the invention is formed from the polycondensation of the diamine component (A) and the dicarboxylic acid component (B). This reaction is based on the condensation of a diamine and a dicarboxylic acid with the formation of amide bonds. The skilled person understands then that the proportion of —NH₂ from the diamine component (A) and the proportion of —COOH from the dicarboxylic acid component (B) are substantially equimolar. The ratio —NH₂/COOH can be comprised between 0.9 to 1.1, preferentially 0.95 to 1.05, even more preferentially between 0.98 to 1.02.

The recurring units of polyamide (PA) typically consist essentially of or consist of recurring units (R_{PA}). The invention thus also relates to a semi-aromatic copolyamide (PA), the recurring units of which are recurring units (R_{PA}) formed from the polycondensation of a diamine component (A) and a dicarboxylic acid component (B) wherein:
the diamine component (A) comprises, consists essentially of or consists of:
   a) a first diamine (DA1) selected in the group consisting of 2,2,4-trimethyl-1,6-hexanediamine (2,2,4-TMD), 2,4,4-trimethyl-1,6-hexanediamine (2,4,4-TMD) and a mixture thereof, and
   b) a second diamine (DA2) selected in the group consisting of 1,9-nonanediamine (C9), 1,10-decanediamine (C10) and a mixture thereof,
      wherein the molar ratio DA1/DA2 of the first diamine (DA1) over the second diamine (DA2) being between 5/95 and 47/53 and wherein the proportion of DA2 in the diamine component (A) is greater than or equal to 53.0 mol % (≥53.0 mol %), this proportion being based on the total amount of diamines in the diamine component (A);
the dicarboxylic acid component (B) comprises, consists essentially of or consists of:
   a) between 70.0 and 95.0 mol. % of terephthalic acid;
   b) between 5.0 (this value being excluded) and 30.0 mol. % of a diacid (DI) selected in the group consisting of isophthalic acid, adipic acid (AA), azelaic acid, sebacic acid, dodecanedioic acid, brassilic acid, 1,4-cyclohexanedicarboxylic acid (CHDA) and a mixture thereof;
   these proportions in mol % being based on the total amount of diacids in the dicarboxylic acid component (B).

More details about the diamine component (A) and the dicarboxylic acid component (B) are provided below.

### Diamine Component (A)

The diamine component (A) comprises, consists of or consists essentially of: a first diamine (DA1) selected in the group consisting of 2,2,4-trimethyl-1,6-hexanediamine (2,2,4-TMD), 2,4,4-trimethyl-1,6-hexanediamine (2,4,4-TMD) and a mixture thereof, and a second diamine (DA2) selected in the group consisting of 1,9-nonanediamine (C9), 1,10-decanediamine (C10) and a mixture thereof.

DA2 is the main or major diamine in the diamine component (A). The proportion of DA2 is greater than or equal to 53.0 mol % (≥53.0 mol %), this proportion being based on the total amount of diamines in the diamine component (A). The proportion of DA2 is more particularly between 53.0 and 95.0 mol %, this proportion being based on the total amount of diamines in the diamine component (A). This proportion may more particularly be between 60.0 and 95.0 mol %.

According to an embodiment, the diamine component (A) comprises a first diamine (DA1) selected in the group consisting of 2,2,4-trimethyl-1,6-hexanediamine (2,2,4-TMD), 2,4,4-trimethyl-1,6-hexanediamine (2,4,4-TMD) and a mixture thereof, and a second diamine (DA2) selected in the group consisting of 1,9-nonanediamine (C9), 1,10-decanediamine (C10) and a mixture thereof. According to this embodiment, the diamine component (A) may comprise 2-methyl-1,8-octanediamine (MODA) with the proviso that the proportion of MODA in the diamine component (A) is lower and equal to 10.0 mol % (≤10.0 mol %), preferably lower and equal to 5.0 mol % (≤5.0 mol %), this proportion in mol % being based on the total amount of diamines in the diamine component (A).

According to another embodiment, the diamine component (A) consists essentially of or consists of the first diamine (DA1) and the second diamine (DA2).

The expression “consist essentially” means in the context of the invention in relation to the diamine component that the diamine component (A) comprises DA1 and DA2 and may also comprise up to 2.0 mol %, preferably up to 1.0 mol %, even more preferably up to 0.5 mol %, of another diamine, this proportion in mol % being based on the total amount of diamines in the diamine component (A). In other words, the diamine component (A) consists of DA1, of DA2 and up to 2.0 mol %, preferably up to 1.0 mol %, even more preferably up to 0.5 mol %, of at least one diamine other than DA1 and DA2, this proportion in mol % being based on the total amount of diamines in the diamine component (A).

DA1 is selected in the group consisting of 2,2,4-TMD, 2,4,4-TMD and a mixture thereof. 2,2,4-TMD is the diamine of formula:

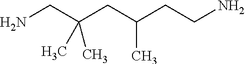

2,4,4-TMD is the diamine of formula:

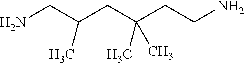

DA1 is conveniently a combination of 2,2,4-TMD and 2,4,4-TMD.

DA2 is selected in the group consisting of 1,9-nonanediamine (C9), 1,10-decanediamine (C10) and a mixture thereof.

DA2 preferably comprises organic carbon of renewable origin, determined according to ASTM D6866-20.

DA2 is preferably biobased. The term “bio-based” applied to a compound means that the compound is made from substances comprising carbon of renewable origin, derived from living or once-living organisms, excluding materials embedded in geological formations and/or fossilized, for instance petroleum-based.

According to an embodiment (E1), DA2 is 1,9-nonanediamine. The 1,9-nonanediamine is preferably bio-based (see also below), so that the polyamide (PA) exhibits a high biobased content.

According to an advantageous embodiment (E2), DA2 is 1,10-decanediamine. The 1,10-decanediamine is preferably bio-based (see also below), so that the polyamide (PA) exhibits a high biobased content.

### Molar Ratio DA1/DA2

In the context of the present disclosure, the molar ratio DA1/DA2 of the first diamine (DA1) over the second diamine (DA2) is between 5/95 and 47/53. This molar ratio may more particularly be:
between 5/95 and 40/60; or
between 15/85 and 47/53; or
between 15/85 and 37/63; or
between 18/82 and 47/53; or
between 8/92 and 37/63; or
between 25/75 and 35/65.

The diamine component (A) preferably does not comprise hexamethylene diamine. The diamine component (A) preferably does not comprise a bis(aminoalkyl)cyclohexane diamine (such as 1,3-bis(aminomethyl)cyclohexane or 1,4-bis(aminomethyl)cyclohexane). The diamine component (A) preferably does not comprise 2-methyl-1,8-octanediamine.

### Dicarboxylic Acid Component (B)

The dicarboxylic acid component (B) comprises: between 70.0 and 95.0 mol. % of terephthalic acid and between 5.0 (this value being excluded) and 30.0 mol. % of another diacid (DI) selected in the group consisting of isophthalic acid, adipic acid (AA), azelaic acid, sebacic acid, dodecanedioic acid, brassilic acid, 1,4-cyclohexanedicarboxylic acid (CHDA) and a mixture thereof, these proportions in mol % being based on the total amount of diacids in the dicarboxylic acid component (B).

If the other diacid (DI) has more than 8 carbon atoms, the proportion of the other diacid (DI) is preferably lower than 20.0 mol %, more preferably lower than 15.0 mol %.

If the other diacid (DI) is such it contains greater than or equal to 8 carbon atoms, the proportion of the other diacid is preferably lower than or equal to 20.0 mol %, more preferably lower than or equal to 15.0 mol %.

The other diacid (DI) can more particularly be selected in the group consisting of isophthalic acid, adipic acid (AA), 1,4-cyclohexanedicarboxylic acid (CHDA) and combinations of two or more of said diacids.

The other diacid (DI) may be one of the diacids listed in Table I. Thus, the other diacid (DI) may be isophthalic acid or adipic acid (AA) or 1,4-cyclohexanedicarboxylic acid (CHDA). The other diacid (DI) is preferably isophthalic acid.

The proportion of terephthalic acid in the dicarboxylic acid component (B) may preferably be at least 80.0 mol %, preferably at least 83.0 mol %, more preferably at least 85.0 mol %. This proportion may also be at least 87.0 mol %.

The proportion of the other diacid (DI) in the dicarboxylic acid component (B) is strictly higher (>) than 5.0 mol %. The proportion of the other diacid (DI) in the dicarboxylic acid component (B) is preferably at most 20.0 mol %, preferably at most 17.0 mol %, more preferably at most 15.0 mol %. This proportion may also be at most 13.0 mol %. It may be noted that the other diacid (DI) may be a combination of two diacids, so that the proportions given herein correspond to the total proportions of diacids (DI).

All these proportions of terephthalic acid and the other diacid (DI) in mol % are based on the total amount of diacids in the dicarboxylic acid component (B).

According to an embodiment, the dicarboxylic acid component (B) consists essentially of or consists of terephthalic acid and the other diacid (DI). The expression “consist essentially” means in the context of the invention in relation to the dicarboxylic acid component (B) that the dicarboxylic acid component (B) comprises terephthalic acid and the other diacid (DI) and may also comprise up to 2.0 mol %, preferably up to 1.0 mol %, even more preferably up to 0.5 mol %, of a diacid other than terephthalic acid and other than DI, this proportion in mol % being based on the total amount of diacids in the dicarboxylic acid component (B). In other words, the dicarboxylic acid component (B) consists of terephthalic acid, of the other diacid (DI) and up to 2.0 mol %, preferably up to 1.0 mol %, even more preferably up to 0.5 mol %, of at least one diacid other than terephthalic acid and other than DI, this proportion in mol % being based on the total amount of diacids in the dicarboxylic acid component (B).

The skilled person understands that the polycondensation of the above-defined monomers lead to a polyamide (PA) comprising the recurring units (R_{PA1}) and (R_{PA2}) which are represented by the following formulae, respectively,

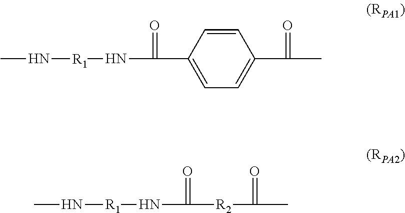

where R₁ is the divalent radical derived from DA1 or DA2 and R₂ is the divalent radical derived from diacid (DI). For instance, if the diacid (DI) is isophthalic acid, (R_{PA2}) is represented by the following formula:

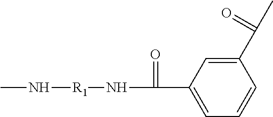

The invention thus also relates to a polyamide (PA) comprising the recurring units (R_{PA1}) and (R_{PA2}) with the following proportions relative to the total amount of recurring units in the polyamide (PA):
between 70.0 and 95.0 mol. % of (R_{PA1});
between 5.0 (this value being excluded) and 30.0 mol. % of (R_{PA2});
   where:
R₁ is a divalent radical of a diamine corresponding to the combination of:
a) a first diamine (DA1) as defined above; and
b) a second diamine (DA2) as defined above;
   the molar ratio DA1/DA2 of the first diamine (DA1) over the second diamine (DA2) being as defined herein;
R₂ is a divalent radical of diacid (DI).

The total proportion of recurring units (R_{PA1}) and (R_{PA2}) is at least 95.0 mol %. This proportion is preferably at least 99.0 mol % or even at least 99.5 mol %.

The polyamide (PA) preferably does not comprise recurring units derived from a lactam. The polyamide (PA) preferably does not comprise recurring units derived from a hexamethylenediamine.

The polyamide (PA) of the invention preferably does not comprise recurring units derived from hexamethylene diamine or from a bis(aminoalkyl)cyclohexane diamine (such as 1,3-bis(aminomethyl)cyclohexane or 1,4-bis(aminomethyl)cyclohexane) or from 2-methyl-1,8-octanediamine.

According to a preferred embodiment, the recurring units (R_{PA}) of polyamide (PA) consist essentially in or consist in recurring units (R_{PA1}) and (R_{PA2}).

### Proportion of Recurring Units (R_{PA1})

The skilled person understands that all details and embodiments relative to the proportions of terephtalic acid and diacid (DI) in the dicarboxylic acid component (B) provided herein can be translated in the corresponding proportions of recurring units (R_{PA1}) and (R_{PA2}).

The proportion of recurring units (R_{PA1}) is between 70.0 and 95.0 mol %. This proportion is preferably at least 80.0 mol %, preferably at least 83.0 mol %, more preferably at least 85.0 mol %. This proportion may also be at least 87.0 mol %.

### Proportion of Recurring Units (R_{PA2})

The proportion of recurring units (R_{PA2}) is between 5.0 (this value being excluded) and 30.0 mol %. This proportion is preferably at most 20.0 mol %, preferably at most 17.0 mol %, more preferably at most 15.0 mol %. This proportion may also be at most 13.0 mol %.

If the polyamide (PA) is based on a diacid with more than 8 carbon atoms, the proportion of (R_{PA2}) is preferably lower than 20.0 mol %, more preferably lower than 15.0 mol %.

### Number Average Molecular Weight (Mn)

The polyamide (PA) of the invention generally has a number average molecular weight (“Mn”) ranging from 1,000 g/mol to 40,000 g/mol, for example from 2,000 g/mol to 35,000 g/mol, from 4,000 to 30,000 g/mol, or from 5,000 g/mol to 20,000 g/mol. Mn can be determined using the following equation (1): Mn=2,000,000/[EG] (1) wherein [EG] is the proportion of end-groups in the PA expressed in mmol/kg. more precisely known methods to measure amine end-groups concentration and acid end groups-concentrations. The end-groups in the polyamide (PA) are generally amine and/or acid moieties. Yet, when the polycondensation involves the addition of an end-capping agent, the amine end-groups are converted, partially or totally, into modified end-group(s). For instance, when the end-capping is an acid such as benzoic acid or acetic acid, the remaining amine groups may be totally or partially converted into an amide end groups such as benzamide or acetamide and these end-groups can easily be quantified by ¹H NMR.

### Inherent Viscosity (IV)

Polyamide (PA) preferably exhibits an inherent viscosity (IV) between 0.50 and 1.70 dL/g.

The IV of polyamide (PA) may more particularly be between 0.70 and 1.00 dL/g or between 0.80 and 1.00 dL/g. The IV of polyamide (PA) may also more particularly be between 1.00 and 1.50 dL/g or between 1.05 and 1.25 dL/g.

In the present disclosure, the inherent viscosity IV is measured according to ASTM D5336-22 with the use of a mixture phenol/trichloroethylene (60/40 wt. ratio).

### End-Groups

The end-groups in the polyamide (PA) are selected in the group of —NH₂, —COOH and amide end-groups. Indeed, the end-groups in the polyamide (PA) may be —NH₂ or —COOH. Yet, when the polycondensation involves the addition of an end-capping agent, these end-groups may be converted, partially or totally, into amide end-groups.

The amide end groups are of formula —NH—C(═O)—R where R is an alkyl group, an aryl group or a cycloalkyl group and/or of formula —C(═O)—NH—R′ where R′ is an alkyl group or a cycloalkyl group. R is more particularly a linear or branched C₁-C₁₈ alkyl group or a C₅-C₁₀ cycloalkyl group. R′ is more particularly a linear or branched C₂-C₁₈ alkyl group.

The amide end groups of formula —NH—C(═O)—R result from the reaction of the end-groups —NH₂ with a monocarboxylic acid (end-capping agent) of formula R—COOH.

The monocarboxylic acid (end-capping agent) may advantageously be selected in the group consisting of benzoic acid; cyclohexanoic acid; R—COOH where R is a linear or branched C₂-C₁₈ alkyl group and combination of two or more of these acids. R is the radical derived from the acid of formula R—COOH.

The monocarboxylic acid (end-capping agent) may more particularly be selected in the group consisting of acetic acid, propanoic acid, butyric acid, valeric acid, caproic acid, lauric acid, stearic acid, 2-ethylhexanoic acid, cyclohexanoic acid, benzoic acid and combination of two or more of these acids.

The monocarboxylic acid (end-capping agent) is more particularly of formula CH₃—(CH₂)ₙ—COOH where n is an integer between 0 and 16. The amide end groups are then of formula —NH—C(═O)—(CH₂)ₙ—CH₃.

The amide end groups of formula —C(═O)—NH—R′ result from the reaction of the end-groups —COOH with a primary amine (end-capping agent) of formula R′—NH₂.

The primary amine (end-capping agent) may advantageously be selected in the group consisting of the amines of formula R′—NH₂ where R′ is a linear or branched C₂-C₁₈ alkyl group. R′ is the radical derived from the amine of formula R′—NH₂.

The primary amine (end-capping agent) is more particularly of formula CH₃—(CH₂)_{n′}—NH₂ where n′ is an integer between 2 and 18. The amide end groups are then of formula —C(═O)—NH—(CH₂)_{n′}—CH₃.

The primary amine (end capping agent) may more particularly be selected in the group consisting of propyl amine, butylamine, pentylamine, hexylamine, 2-ethylhexylamine, n-octylamine, n-dodecylamine, n-tetradecylamine, n-hexadecylamine, stearylamine, cyclohexylamine and combination of two or more of these amines.

The polyamide (PA) may contain a chain limiter, which is a monofunctional molecule capable of reacting with the amine or the carboxylic acid moiety. The chain limiter may more particularly be acetic acid, propionic acid, benzoic acid and/or a C₆-C₁₂ monoalkylamine.

The proportion of the end groups can be quantified by ¹H NMR or by potentiomtric techniques.

### Bio Content

The polyamide (PA) typically exhibits a bio content of at least 30.0%, preferably at least 33.0%, preferably at least 35.0 mol %, even more preferably at least 36.0%, even more preferably at least 37.0%, even more preferably at least 38.0%, even more preferably at least 39.0%, even more preferably at least 40.0%, more preferably at least 45.0%, the biocontent being expressed as the % of organic carbon of renewable origin measured according to ASTM D6866-22.

The bio content is defined as the % of organic carbon of renewable origin. It corresponds to the amount of C calculated from measured ¹⁴C percent in the sample and corrected for isotopic fraction.

Both C9 and C10 diamines can be biobased or issued from petroleum or natural gas.

| | 1,9-nonanediamine (C9) | 1,10-decanediamine (C10) |
|---|---|---|
| | ₂HN—(CH₂)₉—NH₂ | ₂HN—(CH₂)₁₀—NH₂ |
| From petroleum or natural | C9 is traditionally derived | C10 can be prepared from sebacic acid |
| gas (=not biobased) | from petroleum or natural | by the following route: sebacic acid => |
| | gas as it is industrially | sebacic dinitrile => 1,10- |
| | prepared from 1,3-butadiene | decanediamine (C10). Sebacic acid can |
| | by the reductive amination | be produced from adipic acid by an |
| | of 1,9-nonanedial to 1,9- | electrooxidation process developed by |
| | nonanediamine (see | Asahi Chemical Industry in Japan |
| | U.S. Pat. No. 4,510,332 | (chap. 18.2.3 of Brydson's Plastics |
| | of Kuraray). | Materials (Eighth Edition), 2017, isbn |
| | | 978-0-323-35824-8, Prof. |
| | | Marianne Gilbert). See U.S. Pat. No. 3,896,011 of |
| | | Asahi. Adipic acid is traditionally |
| | | derived from petroleum or natural gas |
| | | as it is industrially prepared from 1,3- |
| | | butadiene. |
| Biobased | The biobased 1,9- | Biobased C10 may be prepared from |
| | nonanediamine is generally | sebacic acid derived from castor oil. See |
| | derived from oleic acid, a | Polymers 2016, 8(7), 243 |
| | fatty acid that occurs | (https://doi.org/10.3390/polym8070243) |
| | naturally in various | |
| | resources. Such bio-based | |
| | oleic acid undergoes | |
| | oxidative cleavage to | |
| | produce nonanoic acid and | |
| | azelaic acid, of which the | |
| | latter is subject to nitrilation | |
| | and then hydrogenation to | |
| | obtain 1,9-diaminononane. | |
| | Biobased C9 may be | |
| | prepared according to the | |
| | process disclosed in CN | |
| | 109422656. | |

The polyamide (PA) disclosed herein is prepared from biobased 1,9-nonanediamine (C9) and/or 1,10-decanediamine (C10). This makes it possible to obtain a polyamide (PA) with a high bio content.

According to an embodiment, the polyamide (PA) disclosed herein is prepared from biobased 1,9-nonanediamine (C9) and/or 1,10-decanediamine (C10) exhibiting a bio content of at least 99.000, preferably at least 99.500, preferably at least 99.90%, the biocontent being expressed as the 00 of organic carbon of renewable origin measured according to ASTM D6866-22.

It is also possible to increase the bio content with the use of a biobased terephthalic acid. The bio content as defined above may then be at least 75.0%, or even at least 79.0%. A bio based terephthalic acid may for instance be prepared from a biobased furfural as disclosed in Tachibana, Y., Kimura, S. & Kasuya, K.-i. “Synthesis and Verification of Biobased Terephthalic Acid from Furfural” Sci. Rep. 5, 8249; DOI:10.1038/srep08249 (2015).

### Moisture Absorption and Resistance to Water Ageing

The polyamide (PA) of the invention advantageously exhibits a water uptake at 23° C. lower than 5.0 wt %. The water uptake at 23° C. is determined by (i) providing a specimen shaped according to ISO527 in its dry state (moisture content of less than 0.2 wt. %), (ii) immersing the same in deionized water at 23° C., until reaching a constant weight, (iii) calculating the water uptake with formula:

$$Water uptake = \frac{{W}_{after} - {W}_{before}}{{W}_{before}} \times 100$$

wherein W_{before} is the weight of the shaped specimen in its original dry state and Wafter is the weight of the shaped specimen after water uptake.

The polyamide (PA) of the invention also exhibits resistance to hot water as disclosed below. The test is performed by putting samples in hot water in a closed vessel at 135° C. for 200 hours.

The polyamide (PA) of the invention advantageously exhibits a water uptake at 135° C. for 200 hours lower than 5.0% (≤5.0%). The water uptake at 135° C. for 200 hours is determined by the method comprising the following steps: (i) providing three samples shaped in the form of ISO527 type IA tensile bars in their dry state (moisture content of less than 0.2 wt. %), (ii) immersing the three samples in deionized water at 135° C. for 200 hours, (iii) determining the water uptake for each sample with formula:

$$Water uptake = \frac{{W}_{after} - {W}_{before}}{{W}_{before}} \times 100$$

wherein W_{before} is the weight of the sample in its original dry state and Wafter is the weight of the sample at the end of step (ii); (iv) calculating the water uptake as the arithmetic average of the three water uptakes determined for the three samples.

The polyamide (PA) of the invention advantageously exhibits an IV retention of at least 90.0%, preferably at least 95.0%. The IV retention is determined by the method comprising the following steps: (i) providing a sample shaped in the form of a ISO527 type IA tensile bar in its dry state (moisture content of less than 0.2 wt. %), (ii) immersing the sample in deionized water at 135° C. for 200 hours, (iii) determining the IV retention of the sample with formula:

$$IV retention = {IV}_{after} / {IV}_{before} \times 100$$

wherein IV_{before} and IV_{after} are the inherent viscosities of the sample before and after the test.

### Thermal Properties of the Polyamide (PA)

As noted above, it was surprisingly found that the polyamide (PA) of the invention exhibits a combination of thermal properties. Details are provided below.

### 1) Melting Point (Tm)

The polyamide exhibits a Tm of at least 238° C., preferably at least 240° C. The Tm may preferably be at least 250° C., preferably at least 260° C.

Tm may be at least 265° C. or even at least 270° C.

The Tm is generally at most 300° C. or at most 290° C.

Tm is preferably strictly lower than 290° C. (<290° C.).

Tm may also be at most 280° C.

Tm may be between 238° C. and 300° C. or between 240° C. and 300° C.

Tm may also be between 238° C. and 280° C.

Tm can be measured by Differential Scanning Calorimetry (“DSC”) according to ASTM D3418, notably using a heating and cooling rate of 20° C./min.

Tm can be measured by Differential Scanning Calorimetry (“DSC”) according to ASTM D3418 using a heating and cooling rate of 20° C./min. Three scans are used for each DSC test: a first heat up to 350° C., followed by a first cool down to 0° C., followed by a second heat up to 360° C. The Tm is determined from the second heat up.

Tm can more particularly be measured by the method as described in the experimental section.

### 2) Heat of Fusion (Hm)

The polyamide (PA) is semi-crystalline.

The polyamide (PA) exhibits a heat of fusion (Hm) of at least 30.0 J/g, preferably at least 35.0 J/g.

Hm may be at most 90.0 J/g or at most 80.0 J/g.

Hm may be between 30.0 J/g and 90.0 J/g.

Hm can be measured by Differential Scanning Calorimetry (“DSC”) according to ASTM D3418, notably using a heating and cooling rate of 20° C./min.

Hm can be measured by Differential Scanning Calorimetry (“DSC”) according to ASTM D3418 using a heating and cooling rate of 20° C./min. Three scans are used for each DSC test: a first heat up to 350° C., followed by a first cool down to 0° C., followed by a second heat up to 360° C.

Hm can more particularly be measured by the method as described in the experimental section.

### 3) Glass Transition Temperature (T)

The polyamide exhibits a Tg of at least 100° C. The Tg of the polyamide (PA) may preferably be at least 105° C., preferably at least 110° C., preferably at least 115° C., preferably at least 120° C.

The polyamide (PA) generally exhibits a Tg of at most 140° C.

The Tg may more particularly be between 100° C. and 135° C.

Tg can be measured by Differential Scanning Calorimetry (“DSC”) according to ASTM D3418, notably using a heating and cooling rate of 20° C./min.

Tg can be measured by Differential Scanning Calorimetry (“DSC”) according to ASTM D3418 using a heating and cooling rate of 20° C./min. Three scans are used for each DSC test: a first heat up to 350° C., followed by a first cool down to 0° C., followed by a second heat up to 360° C. The Tg is determined from the second heat up.

Tg can more particularly be measured by the method as described in the experimental section.

As detailed above, the polyamide (PA) of the invention exhibits a combination of thermal properties. The invention thus more particularly relates to a polyamide (PA) exhibiting the following combination of properties:
a Tm between 240° C. and 300° C., preferably between 240° C. and 290° C. (this value of 290° C. being excluded);
a Tg of at least 115° C., preferably at least 120° C.;
a bio-content of at least 30.0%, preferably at least 33.0%, preferably at least 35.0 mol %, even more preferably at least 37.0%, even more preferably at least 40.0%, even more preferably at least 45.0%.

The invention also more particularly relates to a polyamide (PA) exhibiting the following combination of properties:
a Tm between 240° C. and 300° C.;
a Tg of at least 120° C.;
a bio-content of at least 33.0%, preferably at least 35.0 mol %, even more preferably at least 37.0%, even more preferably at least 40.0%, more preferably at least 45.0%.

### 4) Tm/T2 Ratio

As mentioned above, the polyamide (PA) exhibits a combination of thermal properties and it is beneficial to have for a given Tg, a limited Tm. Therefore, Tm/Tg is preferably limited following the inequality of equation 1 (eq 1), preferably the inequality of equation 2 (eq. 2):

$$Tm / Tg < - 0.0372 \times Tg ( in ° C . ) + 6.8402 \qquad ( eq . 1 )$$

$$Tm / Tg < - 0.0372 \times Tg ( in ° C . ) + 6.8002 . \qquad ( eq . 2 )$$

None of the copolyamides of D1 (Table I) follows these two inequalities.

### Embodiment (E*)

According to a preferred embodiment (E*), the invention relates to a polyamide (PA*), the recurring units (R_{PA}*) of which are formed from the polycondensation of a diamine component (A) and a dicarboxylic acid component (B) wherein:
the diamine component (A) comprises, consists essentially of or consists of:
   a) a first diamine (DA1) selected in the group consisting of 2,2,4-trimethyl-1,6-hexanediamine (2,2,4-TMD), 2,4,4-trimethyl-1,6-hexanediamine (2,4,4-TMD) and a mixture thereof, and
   b) a second diamine (DA2) selected in the group consisting of 1,9-nonanediamine (C9), 1,10-decanediamine (C10) and a mixture thereof,
      wherein the proportion of the second diamine (DA2) in the diamine component (A) is between 60.0 and 85.0 mol % and the molar ratio DA1/DA2 of the first diamine (DA1) over the second diamine (DA2) is between 15/85 and 40/60;
the dicarboxylic acid component (B) comprises, consists essentially of or consists of:
   a) between 82.0 and 94.0 mol. % of terephthalic acid;
   b) between 6.0 and 18.0 mol. % of isophthalic acid;
   these proportions in mol % being based on the total amount of diacids in the dicarboxylic acid component (B);
   and exhibiting the following properties:
a Tm between 240° C. and 290° C. (this value of 290° C. being excluded);
a Tg between 115° C. and 135° C.;
optionally a bio-content of at least 33.0%, preferably at least 35.0 mol %, even more preferably at least 37.0%.

The invention also relates to a polyamide (PA*), the recurring units of which consist essentially or consist of the recurring units (R_{PA1}) and (R_{PA2}) with the following proportions relative to the total amount of recurring units in the polyamide (PA):
between 82.0 and 94.0 mol. % of (R_{PA1})

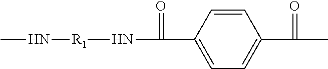

between 6.0 and 18.0 mol. % of (R_{PA2})

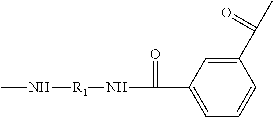

wherein:
   R₁ is a divalent radical of a diamine corresponding to the combination of:
a) a first diamine (DA1) selected in the group consisting of 2,2,4-trimethyl-1,6-hexanediamine (2,2,4-TMD), 2,4,4-trimethyl-1,6-hexanediamine (2,4,4-TMD) and a mixture thereof, and
b) a second diamine (DA2) selected in the group consisting of 1,9-nonanediamine (C9), 1,10-decanediamine (C10) and a mixture thereof;
   the molar ratio DA1/DA2 of the first diamine (DA1) over the second diamine (DA2) being between 15/85 and 40/60;
wherein the proportion of the recurring units derived from DA2 is between 60.0 and 85.0 mol %;
and exhibiting the following properties:
a Tm between 240° C. and 290° C. (this value of 290° C. being excluded);
a Tg between 115° C. and 135° C.;
optionally a bio-content of at least 33.0%, preferably at least 35.0 mol %, even more preferably at least 37.0%.

The proportion of isophthalic acid in the dicarboxylic acid component (B) or the proportion of recurring units (R_{PA2}) in the polyamide may be more particularly between 8.0 and 17.0 mol % or between 8.0 and 12.0 mol %.

All the embodiments, details and properties disclosed herein for polyamide (PA) and recurring units (R_{PA}) are applicable to polyamide (PA*) and recurring units (R_{PA*}).

### Process of Preparation of Polyamides (PA) and (PA*)

The polyamides (PA) and (PA*) described herein can be prepared by any conventional method adapted to the synthesis of polyamides and polyphthalamides. The details that follow relate to polyamide (PA) but are of course applicable to polyamide (PA*).

The polyamide (PA) is generally produced via the polycondensation in the melt.

The polyamide (PA) can be prepared by heating a reaction mixture (RM) comprising or consisting of all the monomers (DA1, DA2, terephtalic acid and DI) in the presence of less than 60 wt. % of water, preferably less than 30 wt. %, preferably less than 20 wt. %, preferably less than 10 wt. %, preferentially with no added water.

As is well known in polycondensation, the reaction mixture comprises the above-referenced diamines and diacids in a quantity such that the proportion of —COOH groups from the diacids and the proportion of —NH₂ groups from the diamines are substantially equimolar. The ratio amine/acid can be comprised between 0.9 to 1.1, preferentially 0.95 to 1.05, even more preferentially between 0.98 to 1.02.

The reaction mixture (RM) preferably comprises a catalyst. The catalyst may be selected in the group consisting of phosphorous acid, ortho-phosphoric acid, meta-phosphoric acid, alkali-metal hypophosphite such as sodium hypophosphite and phenylphosphinic acid. A convenient catalyst used is phosphorous acid.

For control of the molar mass, the reaction mixture (RM) may also further comprise at least one chain limiter (end-capping agent) as disclosed above.

The temperature at which the reaction mixture (RM) is heated must be high enough to induce the reaction between the amine groups of the diamine component (A) and the carboxylic groups of the dicarboxylic acid component (B) and to decrease the viscosity of the mixture. This temperature is generally at least 150° C., preferably at least 200° C. The polycondensation results in the formation of the amide bonds and the release of water as a by-product.

The temperature can be step-wise increased in the course of the polycondensation. An example of step-wise increase is given for example 1 and can be followed for the preparation of the polyamide (PA).

The polycondensation is advantageously performed in a well stirred vessel equipped with means to remove the volatile products of the reaction. As the viscosity of the reaction mixture increases over time, the stirrer is adapted to provide sufficient stirring to the reaction mixture at the beginning of the polymerization and when the conversion of the polycondensation is nearly complete.

The conditions disclosed in the experimental section may conveniently be used for the preparation of the polyamide (PA).

### Thermoplastic Composite (TPC)

The polyamide (PA) or (PA*) are adapted to be used for the preparation of a thermoplastic composite (TPC). The details that follow relate to polyamide (PA) but are applicable to polyamide (PA*).

The thermoplastic composite (TPC) comprises:
a polymer matrix comprising or consisting of: (i) the polyamide (PA) or (PA*) and (ii) optionally at least one plastic additive; and
fibers embedded in the polymer matrix.

The thermoplastic composite comprises a polymer matrix and fibers. The fibers are preferably bonded adhesively or cohesively to the matrix, which generally completely surrounds them. The function of the fibers, which are held in place by the polymer matrix, is to provide improved mechanical properties while minimizing the weight of the composite.

Typically, the proportion of fibers is at least 5.0 wt %, this proportion being given relative to the weight of the thermoplastic composite.

The polymer matrix comprises or consists of: (i) the polyamide (PA) of the invention and (ii) optionally at least one plastic additive, which is generally and preferably blended with the polyamide (PA). The plastic additive may be selected in the group consisting of colorants (e.g., dye and/or pigments), ultraviolet light stabilizers, heat stabilizers, antioxidants, acid scavengers, processing aids, internal lubricants and/or an external lubricants, flame retardants, smoke-suppressing agents, anti-static agents, anti-blocking agents and any combination thereof. The proportion of the plastic additive(s) in the polymer matrix is generally less than 20.0 wt %, this proportion being based on the total weight of the polymer matrix.

The fibers generally exhibit high specific stiffness and strength values.

The fibers can be of inorganic type (e.g. glass fibers) or of organic type (e.g. aramid fibers or carbon fibers). It is also possible to use combination of various fibers.

The fibers may be selected in the group consisting of glass fibers, carbon fibers, aramid fibers, stainless steel fibers, potassium titanate whiskers and combination of two or more of said fibers.

The thermoplastic composite is prepared by any of the techniques well-known by the skilled person, notably as disclosed in Composites Manufacturing 1992, Vol 3, No 4 “Impregnation technology for thermoplastic matrix composites”. These techniques are based on a 1^{st} step by which the polymer composition (C), notably in the powder form, is put into contact with the fibers and on a 2^{nd} step by which heat and pressure are applied on the product obtained at the end of step a). The impregnation technique disclosed in U.S. Pat. No. 5,236,972 may be followed.

In step a), the thermoplastic composition is preferably uniformly and homogeneously distributed around the fibers, notably to reduce the amount of porosity in the final thermoplastic composite. A Tm in the range 240° C.-300° C., preferably 240° C.-290° C. (excluded) is recommended for that.

### Use of the Thermoplastic Composite (TPC)

The thermoplastic composite (TPC) disclosed herein may be used for the preparation of articles for the automotive industry.

### EXPERIMENTAL SECTION

The present examples demonstrate the synthesis, thermal performance, and mechanical performance of the polyamides. The raw materials used to form the samples as provided below:

### Raw Materials Used

The following raw materials were used to prepare the polymer samples: 1,9-diaminononane (produced at Solvay and derived from biobased oleic acid, purity >98.0%), 1,10-diaminodecane (produced at Solvay and derived from biobased castor oil, purity >98.0%), terephthalic acid (from Flint Hills Resources), isophthalic acid (from Flint Hills Resources), 2,2,4-trimethyl-1,6-hexanediamine (2,2,4-TMD), 2,4,4-trimethyl-1,6-hexanediamine (2,4,4-TMD) and a mixture thereof (from Evonik Industries), adipic acid (from Ascend Performance Materials), 1,4-cyclohexanedicarboxylic acid (from Sigma Aldrich), and phosphorus Acid (from Sigma Aldrich).

### Preparation of the Polyamides

All of the copolyamides disclosed in Table I were prepared by polycondensation in an autoclave reactor equipped with a distillate line fitted with a pressure control valve. The procedure detailed below for Ex1 was followed (except for the compositions) for the preparation of all copolyamides of Table II.

### Example 1

The polyamide of Ex1 was prepared by charging into the reactor 4.89 g of 1,9-diaminononane, 0.64 g of a mixture of 2,2,4-trimethyl-1,6-hexanediamine and 2,4,4-trimethyl-1,6-hexanediamine, 5.02 g of terephthalic acid, 0.56 g of isophthalic acid, 5.48 g of deionized water, and 0.0037 g of phosphorus acid. The reactor was sealed, purged with N₂ gas three times. The reactor was heated to 177° C. and held for 25 min, followed by heating to 232° C. and holding for 25 min, followed by heating to 288° C. and holding for 25 min, followed by heating to 321° C. and holding for 15 min. The steam generated was slowly released to keep the internal pressure under 200 psig. Once the temperature was at 321° C. for 15 min, the reactor pressure was slowly reduced to atmospheric pressure over 30 min. 15 min into the depressurization, the reactor was cooled to 302° C. After holding at 302° C. for an additional 15 min and finishing the depressurization, N₂ gas was used to continuously purge the reactor over 25 min. Afterwards, the reactor was cooled to RT and the polymer was retrieved from the reactor.

### Thermal Performance

Tg, Tm and Hm were measured by Differential Scanning Calorimetry (“DSC”) according to ASTM D3418 using a heating and cooling rate of 20° C./min. Three scans were used for each DSC test: a first heat up to 350° C., followed by a first cool down to 0° C., followed by a second heat up to 360° C. Tg, Tm and Hm were determined from the second heat up.

All polyamides of the examples E1-E12 except E1, E3 and E5 follow the inequalities of Eq. 1 and Eq. 2.

TABLE II

| | Diamine component (A)* | | | | Dicarboxylic acid component (B)* | | | | | | | | | | | |
|---|---|---|---|---|---|---|---|---|---|---|---|---|---|---|---|---|
| | | NMDA | DMDA | | | Diacid (DI) | | | | | Tg | Tm | | Hm | IV | Bio-C |
| Ex | TMD | C9 | C10 | DA1/DA2 | TA | IA | AA | CHDA | SA | C18 | (° C.) | (° C.) | Tm/Tg | (J/g) | (dL/g) | content |
| E1 | 10 | 90 | | 10/90 | 90 | 10 | | | | | 124 | 285 | 2.2984 | 45.9 | 0.86 | 48% |
| E2 | 10 | 90 | | 10/90 | 90 | | 10 | | | | 110 | 282 | 2.5636 | 58.3 | 0.65 | 48% |
| E3 | 10 | 90 | | 10/90 | 90 | | | 10 | | | 130 | 283 | 2.1769 | 36.9 | 1.59 | 48% |
| E4 | 30 | 70 | | 30/70 | 90 | 10 | | | | | 124 | 249 | 2.0081 | 52.0 | 0.84 | 37% |
| E5 | 10 | | 90 | 10/90 | 90 | 10 | | | | | 120 | 290 | 2.4167 | 55.5 | / | 50% |
| E6 | 20 | | 80 | 20/80 | 85 | 15 | | | | | 119 | 275 | 2.3109 | 51.8 | 0.74 | 45% |
| E7 | 25 | | 75 | 25/75 | 90 | 10 | | | | | 120 | 277 | 2.3083 | 54.0 | 0.87 | 42% |
| E8 | 30 | | 70 | 30/70 | 90 | 10 | | | | | 121 | 271 | 2.2397 | 55.0 | 0.57 | 40% |
| E9 | 35 | | 65 | 35/65 | 92.5 | 7.5 | | | | | 131 | 247 | 1.8855 | 40.0 | 0.66 | 37% |
| E10 | 35 | | 65 | 35/65 | 90 | 10 | | | | | 125 | 246 | 1.9680 | 50.0 | 0.80 | 37% |
| E11 | 40 | | 60 | 40/60 | 90 | 10 | | | | | 127 | 242 | 1.9055 | 46.0 | 0.82 | 34% |
| E12 | 45 | | 55 | 45/55 | 93 | 7 | | | | | 123 | 240 | 1.9512 | 43.0 | 0.73 | 31% |
| CE13 | 50 | | 50 | 50/50 | 90 | 10 | | | | | 115 | 231 | | 11.7 | 0.32 | 29% |
| CE14 | 10 | 90 | | 10/90 | 50 | 50 | | | | | 109 | ** | | ** | 0.59 | 48% |
| CE15 | | 100 | | | 50 | 50 | | | | | 111 | 247 | | 16.2 | | 53% |
| CE16 | | | 100 | | 50 | 50 | | | | | 110 | 226 | | 10.8 | | 56% |
| CE17 | 50 | | 50 | 50/50 | 92.5 | 7.5 | | | | | 127 | 239 | | 23.4 | 0.70 | 29% |
| CE18 | 35 | | 65 | 35/65 | 90 | | | | | 10 | 113 | 242 | | 35.6 | 1.20 | 35% |
| CE19 | 35 | | 65 | 35/65 | 85 | | | | | 15 | 101 | 240 | | 45.5 | 0.88 | 34% |
| CE20 | 35 | | 65 | 35/65 | 90 | | | | 10 | | 116 | 245 | | 49.4 | 0.95 | 36% |
| CE21 | 35 | | 65 | 35/65 | 85 | | | | 15 | | 109 | 237 | | 22.8 | 0.29 | 36% |

*proportions of the monomers are given in mol % relative to the diamines in the diamine component (A) and to the diacids in the dicarboxylic acid component (B)
** amorphous
*** TA: terephthalic acid; IA: isophthalic acid; AA: adipic acid; CHDA: 1,4-cyclohexanedicarboxylic acid; SA: sebacic acid; C18: octadecanedioic acid
**** IV: measured with the use of a mixture phenol/trichloroethylene (60/40 wt. ratio).

TABLE III

| | Chord | Elongation | IV retention |
|---|---|---|---|
| | Modulus | at Break | after water |
| Ex | (MPa)* | (%)* | ageing (%)** |
| E8 | 2710 | 6.4 | 96% |
| CE13 | 2890 | 2.8 | — |

*measured according to ISO527
**measured according to protocol defined in the description (see § “Moisture absorption and resistance to water ageing”)

1. A polyamide (PA) comprising recurring units (R_{PA}) formed from the polycondensation of a diamine component (A) and a dicarboxylic acid component (B) wherein:
the diamine component (A) comprises:
a) a first diamine (DA1) selected from the group consisting of 2,2,4-trimethyl-1,6-hexanediamine (2,2,4-TMD), 2,4,4-trimethyl-1,6-hexanediamine (2,4,4-TMD) and a mixture thereof, and
b) a second diamine (DA2) selected from the group consisting of 1,9-nonanediamine (C9), 1,10-decanediamine (C10) and a mixture thereof,
wherein the molar ratio DA1/DA2 of the first diamine (DA1) over the second diamine (DA2) is between 5/95 and 47/53; and
wherein the proportion of DA2 in the diamine component (A) is greater than or equal to 53.0 mol % (≥53.0 mol %), this proportion being based on the total amount of diamines in the diamine component (A);
the dicarboxylic acid component (B) comprises:
c) between 70.0 and 95.0 mol. % of terephthalic acid;
d) greater than 5.0 and less than or equal to 30.0 mol. % of another diacid (DI) selected from the group consisting of isophthalic acid, adipic acid (AA), azelaic acid, sebacic acid, dodecanedioic acid, brassilic acid, 1,4-cyclohexanedicarboxylic acid (CHDA) and a mixture thereof,
these proportions in mol % being based on the total amount of dicarboxylic acids in the dicarboxylic acid component (B).

2. The Polyamide (PA) according to claim 1, wherein the diamine component (A) consists of the first diamine (DA1) and of the second diamine (DA2); or wherein the diamine component (A) consists of the first diamine (DA1), of the second diamine (DA2), and up to 2.0 mol % of at least one diamine other than DA1 and DA2, this proportion in mol % being based on the total amount of diamines in the diamine component (A).

3. (canceled)

4. The Polyamide (PA) according to claim 1, wherein the dicarboxylic acid component (B) or consists of terephthalic acid and the other diacid (DI); or wherein the dicarboxylic acid component (B) consists of terephthalic acid, the other diacid (DI), and up to 2.0 mol % of at least one diacid other than terephthalic acid and other than DI, this proportion in mol % being based on the total amount of diacids in the dicarboxylic acid component (B).

5. (canceled)

6. The Polyamide (PA) according to claim 1, wherein if the diamine component (A) comprises 2-methyl-1,8-octanediamine (MODA), the proportion of MODA in the diamine component (A) is less than or equal to 10.0 mol % (≤10.0 mol %), this proportion in mol % being based on the total amount of diamines in the diamine component (A).

7. A Polyamide (PA) comprising recurring units (R_{PA}) formed from the polycondensation of a diamine component (A) and a dicarboxylic acid component (B) wherein:
the diamine component (A) consists essentially of:
a) a first diamine (DA1) selected from the group consisting of 2,2,4-trimethyl-1,6-hexanediamine (2,2,4-TMD), 2,4,4-trimethyl-1,6-hexanediamine (2,4,4-TMD) and a mixture thereof, and
b) a second diamine (DA2) selected from the group consisting of 1,9-nonanediamine (C9), 1,10-decanediamine (C10) and a mixture thereof,
wherein the molar ratio DA1/DA2 of the first diamine (DA1) over the second diamine (DA2) is between 5/95 and 47/53;
the dicarboxylic acid component (B) consists essentially of:
c) between 70.0 and 95.0 mol. % of terephthalic acid;
d) greater than 5.0 and less than or equal to 30.0 mol. % of another diacid (DI) selected from the group consisting of isophthalic acid, adipic acid (AA), azelaic acid, sebacic acid, dodecanedioic acid, brassilic acid, 1,4-cyclohexanedicarboxylic acid (CHDA) and a mixture thereof,
these proportions in mol % being based on the total amount of dicarboxylic acids in the dicarboxylic acid component (B).

8. The Polyamide (PA) according to claim 1, comprising the recurring units (R_{PA1}) and (R_{PA2}) represented by the following formulae, respectively, 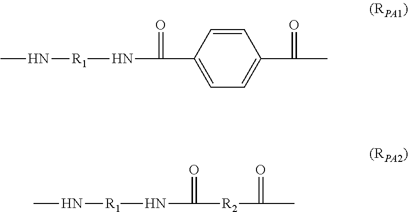
the proportions of these recurring units being as follows:
between 70.0 and 95.0 mol. % of (R_{PA1});
greater than 5.0 and less than or equal to 30.0 mol. % of (R_{PA2});
where:
R₁ is a divalent radical of a diamine corresponding to the combination of:
a) a first diamine (DA1) is selected from the group consisting of 2,2,4-trimethyl-1,6-hexanediamine (2,2,4-TMD), 2,4,4-trimethyl-1,6-hexanediamine (2,4,4-TMD) and a mixture thereof; and
b) a second diamine (DA2) selected from the group consisting of 1,9-nonanediamine (C9), 1,10-decanediamine (C10) and a mixture thereof,
the molar ratio DA1/DA2 of the first diamine (DA1) over the second diamine (DA2) being between 5/95 and 47/53;
R₂ is a divalent radical of a diacid (DI) selected from the group consisting of isophthalic acid, adipic acid (AA), azelaic acid, sebacic acid, dodecanedioic acid, brassilic acid, 1,4-cyclohexanedicarboxylic acid (CHDA) and a mixture thereof;
wherein the total proportion of recurring units RPA1 and RPA2 is at least 95.0 mol % or wherein the recurring units of the polyamide (PA) consist of recurring units RPA1 and RPA2.

9. (canceled)

10. (canceled)

11. (canceled)

12. (canceled)

13. The Polyamide (PA) according to claim 1, wherein the molar ratio DA1/DA2 is:
between 5/95 and 40/60; or
between 15/85 and 47/53; or
between 15/85 and 37/63; or
between 18/82 and 47/53; or
between 8/92 and 37/63; or
between 25/75 and 35/65.

14. (canceled)

15. (canceled)

16. (canceled)

17. (canceled)

18. The Polyamide (PA) according to claim 1, the recurring units (R_{PA*}) of which are formed from the polycondensation of a diamine component (A) and a diarboxylic acid component (B) wherein:
the diamine component (A) comprises:
a) a first diamine (DA1) selected from the group consisting of 2,2,4-trimethyl-1,6-hexanediamine (2,2,4-TMD), 2,4,4-trimethyl-1,6-hexanediamine (2,4,4-TMD) and a mixture thereof, and
b) a second diamine (DA2) selected from the group consisting of 1,9-nonanediamine (C9), 1,10-decanediamine (C10) and a mixture thereof,
wherein the proportion of the second diamine (DA2) in the diamine component (A) is between 60.0 and 85.0 mol % and the molar ratio DA1/DA2 of the first diamine (DA1) over the second diamine (DA2) is between 15/85 and 40/60;
the dicarboxylic acid component (B) comprises:
a) between 82.0 and 94.0 mol. % of terephthalic acid;
b) between 6.0 and 18.0 mol. % of isophthalic acid;
these proportions in mol % being based on the total amount of diacids in the dicarboxylic acid component (B); and
exhibiting the following properties:
a melting point Tm of greater than or equal to 240° C. and less than 290° C.;
a glass transition temperature Tg between 115° C. and 135° C.;
Tm and Tg being measured by Differential Scanning Calorimetry (“DSC”) according to ASTM D3418, using a heating and cooling rate of 20° C./min;
optionally a bio-content of at least 33.0%, the bio-content being expressed as a % of organic carbon of renewable origin measured according to ASTM D6866-22.

19. The Polyamide (PA) according to claim 1, the recurring units of which consist essentially of the recurring units (R_{PA1}) and (R_{PA2}) with the following proportions relative to the total amount of recurring units in the polyamide (PA):
between 82.0 and 94.0 mol. % of (R_{PA1}) 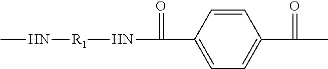
between 6.0 and 18.0 mol. % of (R_{PA2}) 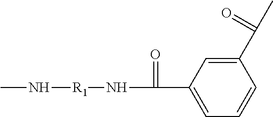
wherein:
R₁ is a divalent radical of a diamine corresponding to the combination of:
a) a first diamine (DA1) selected from the group consisting of 2,2,4-trimethyl-1,6-hexanediamine (2,2,4-TMD), 2,4,4-trimethyl-1,6-hexanediamine (2,4,4-TMD) and a mixture thereof; and
b) a second diamine (DA2) selected from the group consisting of 1,9-nonanediamine (C9), 1,10-decanediamine (C10) and a mixture thereof,
the molar ratio DA1/DA2 of the first diamine (DA1) over the second diamine (DA2) being between 15/85 and 40/60;
wherein the proportion of the recurring units derived from DA2 is between 60.0 and 85.0 mol %; and
exhibiting the following properties:
a melting point Tm of greater than or equal to 240° C. and less than 290° C.;
a glass transition temperature Tg between 115° C. and 135° C.;
Tm and Tg being measured by Differential Scanning Calorimetry (“DSC”) according to ASTM D3418, using a heating and cooling rate of 20° C./min;
optionally a bio-content of at least 33.0%, the bio-content being expressed as a % of organic carbon of renewable origin measured according to ASTM D6866-22.

20. The Polyamide (PA) according to claim 1, exhibiting a bio content of at least 30.0%, the bio-content being expressed as a % of organic carbon of renewable origin measured according to ASTM D6866-22.

21. (canceled)

22. (canceled)

23. (canceled)

24. (canceled)

25. (canceled)

26. The Polyamide (PA) according to claim 1, exhibiting a heat of fusion (Hm) of at least 30.0 J/g, the heat of fusion (Hm) being measured by Differential Scanning Calorimetry (“DSC”) according to ASTM D3418, using a heating and cooling rate of 20° C./min; and/or exhibiting the following properties:
a melting point Tm between 240° C. and 300° C.;
a glass transition temperature Tg of at least 115° C.;
Tm and Tg being measured by Differential Scanning Calorimetry (“DSC”) according to ASTM D3418, using a heating and cooling rate of 20° C./min;
a bio-content of at least 30.0%, the bio-content being expressed as a % of organic carbon of renewable origin measured according to ASTM D6866-22.

27. (canceled)

28. (canceled)

29. (canceled)

30. The Polyamide (PA) according to claim 1, exhibiting a melting point Tm and a glass transition temperature Tg following equation 1 (eq 1):
$$Tm / Tg < - 0.0372 \times Tg ( in ° C . ) + 6.8402 \qquad ( eq . 1 )$$
Tm and Tg being measured by Differential Scanning Calorimetry (“DSC”) according to ASTM D3418, using a heating and cooling rate of 20° C./min.

31. (canceled)

32. The Polyamide (PA) according to claim 1, exhibiting an inherent viscosity (IV) between 0.50 and 1.70 dL/g, the inherent viscosity (IV) being measured according to ASTM D5336-22 with the use of a mixture phenol/trichloroethylene (60/40 wt. ratio).

33. (canceled)

34. (canceled)

35. (canceled)

36. (canceled)

37. (canceled)

38. A process of preparation of a polyamide as defined in claim 1, consisting of heating a reaction mixture (RM) comprising all the monomers (DA1, DA2, terephtalic acid and DI) in the presence of less than 60 wt. % of water.

39. A thermoplastic composite (TPC) comprising:
a polymer matrix comprising: (i) the polyamide (PA) according claim 1, and (ii) optionally at least one plastic additive; and
fibers embedded in the polymer matrix.

40. (canceled)
